(19) United States
(12) Patent Application Publication
(10) Pub. No.: US 2015/0219470 A1
(43) Pub. Date: Aug. 6, 2015

(54) SYSTEM AND METHOD FOR VIRTUAL INTERACTIVE SKI AND SNOWBOARD TOUR GUIDANCE, ENHANCEMENT AND SAFETY

(71) Applicants: NILS E. HOFFMAN, Winhester, VA (US); CHRISTOPHER L. PACKERT, Bentonville, VA (US)

(72) Inventors: NILS E. HOFFMAN, Winhester, VA (US); CHRISTOPHER L. PACKERT, Bentonville, VA (US)

(21) Appl. No.: 14/172,898

(22) Filed: Feb. 4, 2014

(51) Int. Cl. G01C 21/36; G01C 21/20

(52) U.S. Cl. CPC G01C 21/3667; G01C 21/20

(57) ABSTRACT

A method for superior interactive ski and snowboard tour guidance, enhancement and safety. Application software is downloaded into a portable device, and a user uses this software to select among a variety of electronically guided ski and snowboard tours. The geographically accurate 2d trail map shows the area, tour route and other points of interest. A global positioning system shows the user's location, which is identified upon a satellite tour map. The selection of tours offered is based on the user's geographic location, and includes tours customized upon a number of factors, such as the type of terrain, natural points of interest, snow conditions, duration and other factors. As a safety feature and to maximize the user's ski experience, the user chooses an ability level and a selection of tours suitable to that ability level is displayed.

### CROSS REFERENCE TO RELATED APPLICATION(S)

This application claims the benefit of U.S. Provisional Application No. 61/761,262 entitled “System and Method for Virtual Interactive Ski and Snowboard Tour Guidance, Enhancement and Safety.” filed on Feb. 6, 2013, the subject matter of which is hereby incorporated therein by reference in its entirety.

### BACKGROUND OF THE INVENTION

1. Field of the Invention

The present invention is directed to a method for providing improved tour guidance, general enhancement and improved safety of a skiing or snowboarding experience by and more particularly, to a virtual and interactive method of doing so through the use of software and GPS.

2. Description of the Prior Art

For skiers wanting to get maximum enjoyment and safety from their trip to a resort of other ski location, being able to obtain information, such as general tour and resort information, location of trails, ski locations for specific skill levels, locations of points of interest, such as unique ski challenges or scenic views, weather and slope conditions, is imperative, and in certain situations, can be the difference between life and death. There are a number of well-known methods of providing such information. However, all of these suffer from a number of drawbacks.

A skier can, for example, consult written media such as books or brochures. However, these media can be cumbersome to carry around, particularly when the skier is consulting several items such as a book for general area information, a map to navigate, and brochure or pamphlet provided by a particular resort for specific resort information. Further, these do not provide up-to-date information on matters such as weather or slope conditions, or take changes of trails into account between printings. Further, a map, while providing a picture of the area, does not tell the skier their specific location within the map area, so that unless the skier has an observable point of reference such as a landmark, the skier may either not be able to find slopes or items of interest, or even become lost within the resort. Maps, which can be loaded onto a personal device and referenced, suffer from the same difficulty, and finding such a point of reference can be even more difficult than with a paper map because of the limiting size of any portable device a skier could bring out onto the slopes.

Another solution is to hire a tour guide to take one around the resort. However, this is both time-consuming and expensive. It is also not ideal because the skier must then schedule around when the tour guide is available. Further, it does not guarantee the skier will be shown or taken to specific places of interest as the tour guide and skier's idea of such may be different.

It is also known generally to use Global Positioning System (GPS) technology with a portable device to provide location information to a user, and GPS is particularly used for driving in areas where the user's location can overlay a constantly maintained digital map. However GPS, though it does allow one to track one's own progress, is of limited use in most ski areas, particularly those that are large or in remote locations, as they tend to provide location information, but little or nothing about the location or route of specific slopes designed for those of differing skill levels and how to guide oneself through the correct route. There is also little or no information about surrounding topography, or specific points of interest. Further, simple use of GPS and other known similar methods cannot provide the extremely detailed information about each slope that makes the user feel as if being briefed by a local with first-hand knowledge. And if such volumes of detailed information were available, the user would have to wade through some, or much, information of little or no interest to get to what was of interest, an experience likely to annoy and frustrate the user.

At most ski resorts and areas, there are areas and trails designated for skiers and snowboarders of different skill levels. It is important, because of the speeds, topography and risk of injury involved, that skiers and snowboarders, particularly those less experienced, know which trails and areas are appropriate to their skill levels, their exact locations, and that they not mix these up with those of higher difficulty. Skiing in terrain above a skier's ability can be very dangerous for the skier, and even for those around the skier because of risk of high-speed collisions, and the creation of unexpected obstacles that all must avoid on the slopes.

Also, scenic opportunities and points of interest, as with a number of other methods, can be missed because, since placing signs in front of all of them is impractical at best, finding them depends both on the user knowing they are there and knowing how to locate them.

Another method known in the art is to provide a system wherein a portable wireless device, such as a cellphone or computer is tied to a website containing general information of interest about a given resort. However, this is dependent upon the existence of a specific website with the information. It's also completely dependent on there being a working wireless connection for the device to the website, without which the user will have nothing. Finally, such a website, while it can provide general information to a user, is not interactive with the user in such a way as to be responsive to a user's specific preferences and needs, and may not provide the information that the user wants, and exactly when the user wants it. This is particularly problematic in skiing, as portions of many ski areas are in remote locations that may not have wireless reception.

In addition to the ruggedness of terrain and remoteness that is part of the skiing experience, all of the safety issues mentioned, such as becoming lost, can take on a special importance at large ski resorts because of their sheer size. Vail, for example, has about 5,300 skiable acres, so that if something does go wrong in such a place, help may be too far away. As in almost no other sport, safety concerns are of great importance in skiing, as skiers can and do wander away, get lost, get caught by bad weather, and ski in terrain too rugged for their skill level, and as a result, are injured and die every year. Accordingly, it is important to provide skiers any means of obtaining correct and up-to-date guidance and information that can prevent such tragedies.

Therefore, there is a need within the tour guidance art for a system designed specifically for skiers and snowboarders, providing them with complete trail guidance that is adjustable to individual skill level, as well as navigational, slope, weather, condition, tour and scenic information, and other information to enhance the ski experience, in real time, and displayed and organized according to the specific preference of a skier, so as to be as useful to the skier, and enhance the ski experience as much as possible.

### SUMMARY OF THE INVENTION

The present invention provides a method for superior interactive ski and snowboard tour guidance, enhancement and safety. A portable wireless device, such as a wireless “smart phone” is provided which is capable of downloading and running software designed to perform a specific task the user wishes to perform (application software, or in common usage, an “app”).

A user downloads setup application software into a mobile device, the user begins by selecting that application software from a screen on the device. The application software is then activated.

The individual software applications are divided geographically, by ski location. These can be simply specific geographic areas of interest, such as a hill or mountain, or by resorts. Once the software is activated, the user can choose to display a limited number of sample tours, at a single or various location, for free download.

When the user has either chosen to bypass the sample tours or is done browsing the tours, the user can choose to display a set of locations for purchase or to display purchased locations, thereby choosing whether to be taken to an area where the user can browse among application software for locations that are not already purchased, or go to purchased software the user already has. If the user selects locations for purchase, a list of choices for purchase will be displayed 40, and each location choice provides means to select that location's application software for purchase.

When the user selects the location to purchase, the user is taken to a place where that location can be purchased. When the purchase is complete, the application software data is unlocked on the user's mobile device and placed into an electronic folder of purchased locations now owned by the user.

The user can then elect to move into already owned locations, and a display of purchased locations will appear.

In addition to a display of the list of resorts that have been purchased, additional information about each resort may be displayed, such as, for example, the amount of new snow received in the past 24 hours and/or an icon that notifies the user whether the application software for each location has been updated. An option to select each location will also be shown, and the user then selects a particular location.

Once a location is selected, the user can begin to select and use their preferred tour at that location and obtain other information of interest. The user can enter a tours area to browse the available tours of the location, enter a stored tours area containing tours that have previously been stored by the user, or get reports to provide users with access to other information about the location.

If the user chooses to select a tour, the user is provided with tour choices based upon ability level, such as, e.g., novice, intermediate, advanced and expert (which are the ski and snowboard industry standard descriptive terms), and asked to select the appropriate skill level, as a safety feature and to maximize the user's ski experience. In this embodiment there are four primary levels to choose among. Thereby, a user can avoid either skiing on a route below the user's abilities, while avoiding mutes above the user's ski level.

The report area contains non-tour information of interest such as, e.g., resort information and weather. Resort information can provide the user with information regarding the snow conditions of the mountain, trail and lift openings and closures and weather can provide the weather report for that location. Information for these two information sources is brought in, and constantly updated, through RSS feeds via the internet. All of this information can be crucial to providing a user with information about the conditions at a location before and while skiing there. This can maximize the ski experience for the user by letting the user know when conditions are most favorable, helping the user decide when and where to ski, or save the user much time and trouble if conditions are unfavorable.

As alluded to previously, within each set of choices, the user is typically free to navigate among the choices presented on the screen of the mobile device. When the user selects a skill level, the user is taken to a select tour area having a screen containing a list of the tours that have been developed for that ability level. A number of tours, each based upon the kind of experience the user wants on that particular tour, are provided at each ability level. These tours are designed to incorporate multiple factors, such as, but not limited to specific snow and ice conditions, terrain type, features of interest and length to help create for the user a specific experience.

A few illustrative examples are provided. In one example, the user can select a “Warm-Up Tour” to help the user prepare for more rigorous exercise. This tour has a duration of approximately one hour long and is designed to navigate the user around easier terrain within the user's ability level. Other tours may be designed to help the user take maximum advantage of the terrain features at that particular location. If the location is a mountain with superior terrain parks, a tour may be designed to help the user make the most use of these parks. If there are a network of groomed runs, a tour may be designed that will let the user make maximum use of these runs, within the user's ability level. An “Explore The Mountain Tour” can be designed to navigate the user from one side of the resort to the other while remaining on trails that are suited for their ability level. A “Powder Tour” can be provided to help the user take maximum advantage when a location has received a large quantity of snow. The “Powder Tour” can be designed so as to navigate the user to steeper southern-facing trails in the morning when temperatures remain low, and northern trails, that do not receive direct sunlight and will remain in good condition throughout the day, in the afternoon, thereby maximizing the time of best snow conditions for the user. Further, a “Spring Tour” can be designed to minimize ice conditions, and a “Next Level Tour” can be chosen that will increase the difficulty of the terrain for the user and blend difficult terrain of one level with easier terrain of the next level.

The user selects a tour from this page and proceeds to use and enjoyment of the tour. If the user elects to enter stored tours, rather than entering tours or Reports, respectively, the user will be provided with a list of tours the user has decided to previously store in this area. The user selects a stored tour, and proceeds to use and enjoyment of that tour.

Once a tour has been selected, the user is taken to an introduction screen, and the user starts the tour from this page. The user is taken to a tour map screen showing the area of the tour and specific trails and lifts to be followed. When the user is within the area of the tour, the user's location within the tour area will be indicated by the use of mobile GPS technology, and the GPS location identified upon an original 2d tour map. Once the tour has started, the user can follow and record the user's progress of the tour on the 2d tour map. This will also contain an auto feature that will, by coordinating with the user's GPS position, automatically cycle through the tour as the user's position moves through the tour, so that the tour advances automatically with the user's progress. The tour page allows the user to scroll through the tour so they can see each stage of the tour, one stage at a time, through use of a forward and backward button.

Further, the tour map can be set to identify the location of specific area features of interest, such as terrain parks, gladed runs, signature trails, dining opportunities, etc. Further, along with the GPS locations comes additional information including scenic opportunities, historic facts and tips about the feature. The user can turn the display of prominent features on or off depending on preference.

In addition to these features, other functions to assist with the tour experience are present, which may be varied depending upon suitability and need, such as, e.g., an icon which will activate an automatic “orient” feature, a feature that changes the display to a designated satellite view map, a feature that can show or hide tour directions in text form, and a tool bar. The tool bar can display various tools, such as, for example, a tour details tool, a tool that takes the user to a page of resort information and weather, a marker tool that takes the user to a screen where the user can add their own marker and a record route tool takes the user to a screen where the user can record their own route. Another tool lets the user add the tour to stored tours. A camera tool will allow users to take a picture that will have the coordinates of the image geotagged to the location of the picture. Finally, a music tool allows the user to listen to digitally downloaded music while using the application software.

### BRIEF DESCRIPTION OF THE DRAWINGS

FIG. 1 is a block diagram showing the overall method of the invention.

FIG. 2 is a block diagram showing a portion of the method of FIG. 1 in expanded detail.

FIG. 3 is a block diagram showing a portion of the method of FIGS. 1 and 2 in expanded detail.

### DESCRIPTION OF SPECIFIC EMBODIMENTS

Referencing now the drawings in which like numerals reference like elements throughout the views, a method for interactive touring to enhance the ski and snowboard experience is depicted.

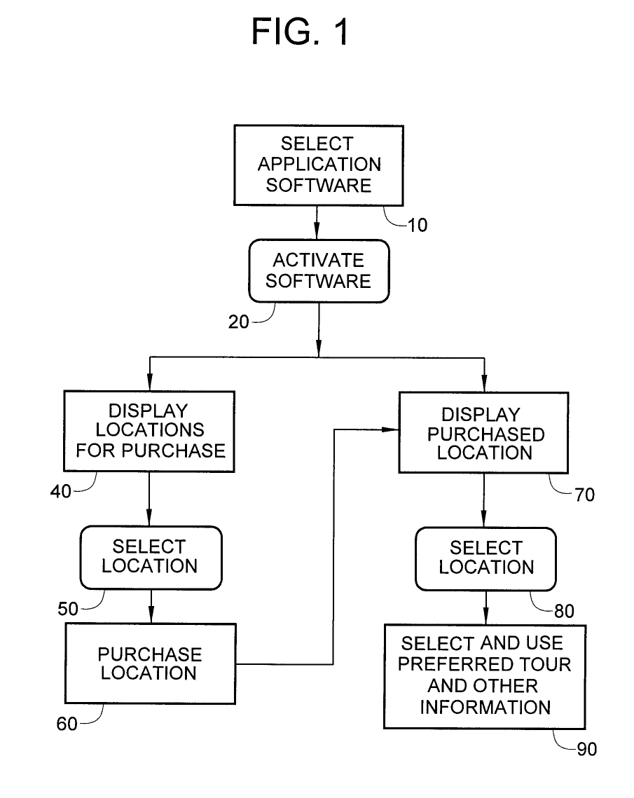

Turning to FIG. 1, an embodiment showing the inventive method in overall form is shown and will be discussed. A portable wireless device is provided which is capable of downloading and running software designed to perform a specific task the user wishes to perform (application software, or in common usage, an “app”). In this embodiment and throughout, a wireless cell phone with software that allows the phone capabilities beyond standard number dialing, often known in the art as a “smart phone” will be used as the portable wireless device, but it is to be understood that any suitable wireless device capable of performing the task can be utilized. It is also to be understood that while in this embodiment, reference is usually made to skiing, the method herein can also be used for skiing or snowboarding. Further, it is to be understood that the terms “user” and “skier” are used interchangeably herein, and are understood to mean a skier or snowboarder using the method herein.

After a user has downloaded setup application software into the user's mobile device, the user begins by selecting that application software 10 from a screen on the device, either by touching an icon for it on a screen, entering a request for it into the device, voice command or other suitable means.

The application software is then activated. 20 The software may be activated immediately upon selection, or a request to perform some action to activate the software can appear, In this embodiment, this action to activate takes the form of touching a button agreeing to a legal disclaimer.

It is to be understood throughout this description that selections can be made by any suitable means in the art, such as touching an appropriate portion of an interactive screen, pushing a physical button, voice command or other suitable means. In this embodiment, selections are made throughout by touching a portion of an interactive touch screen of the cell phone that simulate the actions of physical buttons.

The individual software applications are divided geographically, by ski location. These can be simply specific geographic areas of interest, such as a hill or mountain, or by resorts. In this embodiment, the locations are specific resorts.

Once the software is activated, the user can select one of several options. The user can choose to display a limited number of sample tours, at a single or various location, for free download (not shown). These sample tours can provide enough of the functionality of the full application software to give a user the feel of using the application software. In this embodiment tour information on several selected trails at a pre-determined location (discussed herein below) is provided.

When the user has either chosen to bypass the sample tours or is done browsing the tours, the user can choose to Display Locations for Purchase 40 or to Display Purchased Locations 70. The user chooses whether to be taken to an area where the user can browse among application software for locations that are not already purchased, or go to purchased software the user already has. In this embodiment, the choices appear on the screen of the mobile device as “resorts” and “my resorts,” respectively.

If the user selects locations for purchase (Resorts), a list of choices for purchase will be displayed 40. In addition, each location choice may have some information shown regarding that location, to enhance user interest. In this embodiment, how much snow the location has received in the past 24 hours, provided by a web feed, is shown. Each location choice provides means to select that locations application software for purchase, such as, in this embodiment, a “buy” icon next to the location.

When the user selects the location to purchase 50, the user is taken to a place where that location can be purchased 60, such as, in this embodiment, an online store. When the purchase is complete, the application software data is unlocked on the user's mobile device and placed into an electronic folder of purchased locations now owned by the user.

Any time after the software for the location of interest is downloaded, the user can elect to move into already owned locations, which will appear on the phone screen as “My Resorts” in this embodiment, and a display of purchased locations will appear.

At the Display Purchased Locations area 70, in addition to a display of the list of resorts that have been purchased, additional information about each resort may be displayed, such as, for example, the amount of new snow received in the past 24 hours and/or an icon that notifies the user whether the application software for each location has been updated. An option to select each location will also be shown, which in this embodiment, takes the form of a button for each resort. The user then selects a particular location 80.

Once a location is selected, the user can begin to select and use their preferred tour at that location and obtain other information of interest 90

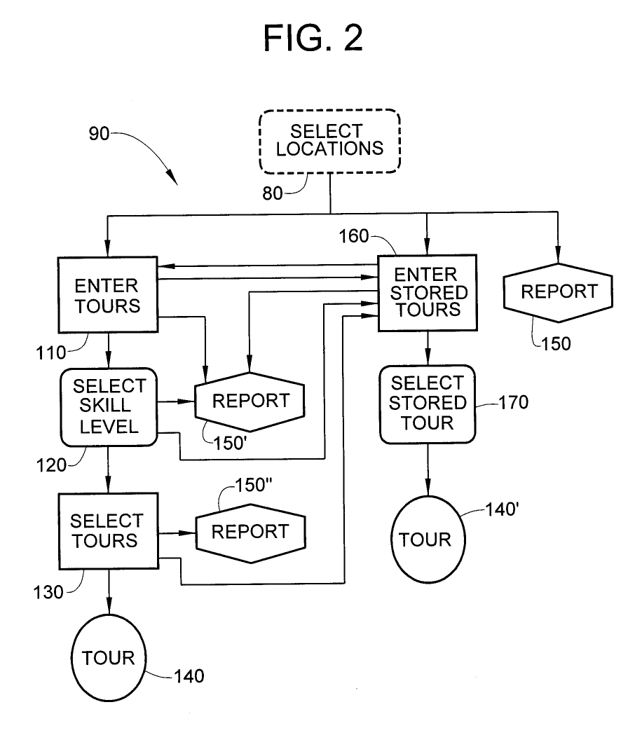

Turning to FIG. 2, selection and use of a preferred tour, and obtaining other information 90 will be discussed in greater detail.

Once the resort has been selected 80, the user can Enter Tours 110 to browse the available tours of the location, Enter Stored Tours 160 containing tours that have previously been stored by the user for convenient reference, or get Reports 150.

In this embodiment, the tour selections 110, 160 are indicated by the respective smartphone buttons “Select Tour,” and “Favorite Tours. Additional options, represented here by touch buttons, can be used to provide users with access to other information about the location such as Reports 150. The number of selections and types of information may vary. In this embodiment, there are two representative touch buttons titled “Resort Info” and “Weather.”

If the user chooses select a tour, the user enters tours 110. The user is provided with choices based upon ability level, and asked to select the appropriate skill level, as a safety feature and to maximize the user's ski experience. In this embodiment there are four primary levels to choose among. These include Novice. Intermediate, Advanced and Expert. Thereby, a user can avoid either skiing on a route below the user's abilities to maximize interest and enjoyment, while avoiding routes above the user's ski level to help the user avoid injuries and possibly even death.

A number of tours, based upon the kind of experience the user wants on the tour and other conditions, are provided. To give an idea of the variety and types of tours that can be displayed, a few examples, among many possible tours, are offered. As one example a tour designed for spring time is provided, in which areas with the iciest conditions are located and a route is calculated and shown to the user to take the user around the mountain to best avoid those conditions. Another tour designed for general exploration, wherein a route is calculated and provided to familiarize the user with an entire area, such as a mountain or resort and surrounding terrain. Another tour designed for a morning warm-up is provided, wherein a route designed to warm a user up at the start of the day is calculated and shown.

There can also be other selections at each of the steps herein, and in this embodiment usually are, to navigate to other locations within the menu, a feature repeated throughout this method. In this embodiment, there are three selections at the bottom of the screen; “select tours” (with an indicator that this is the user's current location, such as a button that shows darker or looks depressed, “Favorites”, and “Mountain Info”. The “Favorites” selection takes the user to the Stored Tours area 160 (to be discussed shortly) and the “Mountain info” selection takes the user to the Report area 150′.

The report area 150′ contains non-tour information of interest. In this embodiment, this report area 150′ is titled “Mountain info” and contains information on the “Resort Info” and “Weather.” “Resort Info” provides the user with information regarding the snow conditions of the mountain, trail and lift openings and closures and “Weather” provides an updated weather report from a suitable information source for that location. Information for these two information sources is brought in, and constantly updated, through RSS feeds via the internet. All of this information can be crucial to providing a user with information about the conditions at a location before and while skiing there. This can maximize the ski experience for the user by letting the user know when conditions are most favorable, helping the user decide when and where to ski, or save the user much time and trouble if conditions are unfavorable. This information is the same as that provided by the Reports selection 150 mentioned earlier, though the visual layout and presentation of the information may differ.

As alluded to previously, within each set of choices, the user is typically free to navigate among the choices presented on the screen of the mobile device. For example, if the user moves to Enter Stored Tours (“Favorite Tours”) 160 or Reports 150′ the user can move between one of these and the other, or back to Enter Tours 110. The arrows of the figures herein are primarily to indicate and clarify the forward direction of flow of the method. Accordingly, most of these “back and forth” movements within screens are not indicated in the figures for the sake of clarity.

When the user selects a skill level 120, the user is taken to Select Tour 130 having a screen containing a list of the tours that have been developed for that ability level, along with the approximate duration of each tour. As with the Enter Tours 110 step, the Enter Skill Level 120 and Select Tour 130 steps each have additional selections available to take the user to the Enter Stored Tours area 160 or Reports 150′, 150,″ respectively. Reports 150′ and 150″ provide the same information in the same manner as each other, and are only presented as two distinct locations for clarity and convenience of description.

The user selects a tour from this page and proceeds to use and enjoyment of the tour 140.

If the user elects to Enter Stored Tours 160, rather than Enter Tours 110 or Reports 150, respectively, the user will be provided with a list of tours the user has decided to previously store in this area. Thereby, a user's favorite tours are readily accessible and easy to find. As in previous selections, the Enter Stored Tours 160 screen also provides other selections to toggle through, such as, in this embodiment, Enter Tours 110 and enter Reports 150. The user selects a stored tour 170, and proceeds to use and enjoyment of that tour 140′.

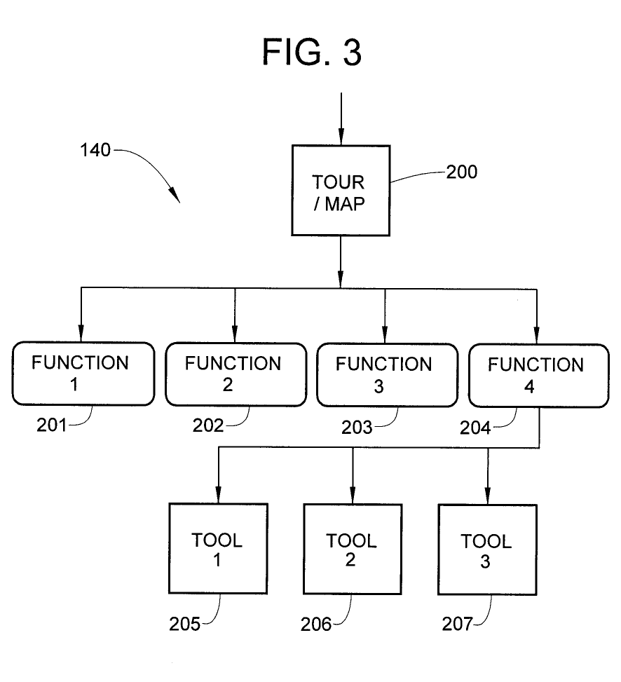

Turning to FIG. 3, the use and enjoyment of a specific tour 140, 140′ is described in further detail.

Once a tour has been selected, the user is taken to an introduction screen that provides the user with a brief summary of the tour written in a conversational tone. The user starts the tour from this page by pressing the “start” button (not shown).

The user is taken to a tour map screen 200 showing the area of the tour and specific trail and chairlifts to be followed. When the user is within the area of the tour, the user's location within the tour area will be indicated by the use of mobile GPS technology, and the GPS location identified upon an original 2d tour map. Once the tour has started, the user can follow and record the user's progress of the tour on the 2d tour map. This page will also contain an auto feature that will, by coordinating with the user's GPS position, automatically cycle through the tour as the user's position moves through the tour, so that the tour advances automatically with the user's progress. The tour page allows the user to scroll through the tour so they can see each stage of the tour, one stage at a time, through use of a forward and backward button.

For further clarity, the tours can be color coded by ability level, as well as other objects of interest. For example, in this embodiment, green trails indicate novice level, blue indicate intermediate, black indicate advanced, and yellow is used for expert. These colors coincide with the ability levels mentioned earlier. Lifts and gondolas are marked in red. The route of the specific tour appears separately in orange for ease of identification.

The combination of GPS positioning and overlay on a specifically designed tour map provides the user with the advantages, and feeling of, being personally guided on the tour. The user always knows their location, and where they need to go. Even if a wireless signal is unavailable to the mobile device, much important functionality is maintained. Most importantly, the original downloaded location map with the automated tour guide, will still be present on the mobile device, while the user's GPS location feature will continue to work.

Further, the tour map can be set to identify the location of specific area features of interest. These features could include natural and man-made items, such as cliff bands, tree runs, jumps, potential powder stashes, steep slopes, restaurants, and scenic opportunities. Further, along with the GPS locations comes additional information including scenic opportunities, historic facts and tips about the feature. Additionally, the user can turn a display of prominent features, such as cliffs and tree runs, on or off depending on preference.

In addition to these features, other functions to assist with the tour experience are present. The number and type of functions may be varied depending upon suitability and need, but here, there are four function buttons at the bottom of the screen 201, 202, 203, 204. One function is an icon which, when selected, will activate an automatic “orient” feature 201 that uses GPS to center the screen to the location of the user as a navigational aid. The second function button changes the display to a designated satellite view map 202 such that the user can see their location on the satellite view map. This map display contains the same map and tour functionality as described herein, and is synchronized with the downloaded application software. The third function button can show or hide tour directions in text form 203. The fourth button deploys a tool bar 204. This tool bar displays various tools, represented herein as 205, 206, 207 to perform functions of interest to the user.

In this embodiment, the toolbar can provide, for example, Tour Details, which brings up a list of the trails and chairlifts of the tour in sequential order, a tool that takes the user to a page of Resort Information and Weather, as in Reports 150, and Reports 150′, 150″. A marker tool takes the user to a screen where the user can add their own marker and a record route tool takes the user to a screen where the user can record their own route. The marker and record route tools allow the user to send their recordings to internet locations of choice, such as email and social media. Another tool lets the user add the tour to stored tours 160, where it will appear when the user next enters stored tours 160. A camera tool will allow users to take a picture that will have the coordinates of the image geotagged to the location of the picture. Finally, a music tool allows the user to listen to digitally downloaded music from the user's own music collection.

By this invention, a user will obtain the best of both worlds, experiencing each location from the perspective and knowledge of a local guide, but with complete independence to choose the tour and other elements of interest, thereby providing the user the best ways to enjoy the slopes, no matter the conditions.

### CONCLUSION

While various aspects and embodiments of the invention have been described above, other aspects and embodiments will be apparent to those skilled in the art. The above description are for purposes of illustration and are not intended to be, and should not be taken as, limiting the scope of the invention as defined by the following claims.

1. A method for conducting a virtual interactive ski or snowboard tour, comprising the steps of:
accessing interactive ski snowboard tour application software located within a portable electronic wireless device, said application software being capable of providing at least one virtual location a user can access, and being capable of providing at least one virtual tour within each location a user can access,
selecting a location for a tour, wherein the location having at least one interactive tour, each tour having at least two skill levels,
selecting a skill level,
selecting an interactive tour at that location from those made available by the interactive software for the selected skill level, and
proceeding to an electronic two-dimensional tour map screen and indicating the location of one or more steps of the tour, the location of a user within the tour area, or both, on the tour map screen.

2. The method according to claim 1, wherein the user's location within the tour area is indicated, by global positioning satellite technology.

3. The method according to claim 1, further comprising the steps of:
downloading the interactive ski snowboard tour application software into the portable electronic wireless device,
selecting that application software from a screen on the device,
and activating the software.

4. The method according to claim 1, wherein selections are made by touching an appropriate portion of an interactive screen, pushing a physical button or giving a voice command.

5. The method according to claim 1, wherein the location a user selects is a virtual representation of a geographic location.

6. The method according to claim 5, wherein the location is a hill, mountain, ski resort or combination of these.

7. The method according to claim 1, further comprising the step of providing information about the selected location on a screen of the portable electronic device,
and wherein the information is transmitted to the device by an electronic internet feed,
and wherein the information concerns the amount of snow the location has received within a pre-determined period of time.

8. The method according to claim 1, further comprising the step of providing the steps of:
selecting specific application software for a locations for purchase,
purchasing the specific application software from a pre-determined virtual source, and
transferring the specific application software into a pre-determined storage location within the portable electronic device.

9. The method according to claim 1, wherein the skill levels include novice, intermediate, advanced and expert.

10. The method according to claim 1, further comprising the step of providing the user with a display on the screen of the interactive electronic portable device, updated at pre-determined intervals, indicating the user's position within the tour.

11. The method according to claim 10, wherein the user's location is transmitted is obtained and transmitted to the portable electronic device using a global positioning satellite system.

12. The method according to claim 11, further comprising the step of centering the location of the user on an interactive screen using the global positioning satellite system.

13. The method according to claim 1, wherein the tour is displayed in at least two individual stages, and the user can navigate through the tour by navigating the at least two individual stages of the tour.

14. The method according to claim 1, further comprising the step of color coding each ability level within a tour location.

15. The method according to claim 1, further comprising the step of configuring the interactive tour map to identify the location of one or more specific areas or features of interest along the tour, and color coding the specific areas or features of interest.

16. The method according to claim 1, further comprising the step of providing a toolbar on an interactive screen of the portable electronic device, the toolbar capable of providing at least one kind of information that can be selected by a user, and providing the type of information selected onto the screen.

17. The method according to claim 16, wherein the location is a resort, and the at least one kind of information is regarding the number and location of trails and chairlifts, weather information, or information about the resort.

18. A method according to claim 1, further comprising the step of:
providing an electronic tool capable of allowing a user to add a movable marker onto the tour indicating the location of the user,
updating the movable marker at pre-determined intervals, and
recording the route taken by the user with the marker.
